(19) United States
(12) Patent Application Publication
(10) Pub. No.: US 2018/0136742 A1
(43) Pub. Date: May 17, 2018

(54) INFORMATION PROCESSING DEVICE, ELECTRONIC APPARATUS, METHOD OF CONTROLLING INFORMATION PROCESSING DEVICE, AND CONTROL PROGRAM

(71) Applicant: SHARP KABUSHIKI KAISHA, Sakai City, Osaka (JP)

(72) Inventors: TOHRU KASHIWAGI, Sakai City (JP); TOMOKI KATO, Sakai City (JP); AKIHIRO ISOO, Sakai City (JP); SHINYA OKUDA, Sakai City (JP)

(21) Appl. No.: 15/572,462

(22) PCT Filed: Sep. 7, 2016
(86) PCT No.: PCT/JP2016/076301

§ 371 Date: Nov. 7, 2017

(30) Foreign Application Priority Data
Sep. 29, 2015 (JP) 2015-192094

(51) Int. Cl. G06F 3/0346; G06F 3/03

(52) U.S. Cl. CPC G06F 3/0346; G06F 3/0304

(57) ABSTRACT

A device of the present invention makes it possible to detect lifting of the device itself with a reduced possibility of false detection. The device of the present invention includes a lifting control section (52) which determines, under the following conditions, that the lifting has been carried out. The conditions are as follows: the lifting control section (52) obtains acceleration information indicative of acceleration detected by the acceleration sensor (11); a waveform representing values of acceleration indicated by the acceleration information with respect to elapsed time has a maximum value and a minimum value; the acceleration is greater than a first predetermined value during a first predetermined period including a time point of the maximum value; and the acceleration is lower than a second predetermined value during a second predetermined period including a time point of the minimum value.

### TECHNICAL FIELD

The present invention relates to an information processing device which detects that an electronic apparatus has been lifted, an electronic apparatus including the information processing device, and the like.

### BACKGROUND ART

Recent mobile terminals, typically, smart phones include various sensors and are becoming multifunctional. For example, Patent Literature 1 discloses a mobile terminal which includes an authenticating section and a posture detecting section. In a case where authentication of a subject by the authenticating section has succeeded, the mobile terminal activates an application which corresponds to a posture of a housing which has been detected by the posture detecting section.

### CITATION LIST

### Patent Literature

[Patent Literature 1]

Japanese Patent Application Publication Tokukai No. 2013-232826 (Publication date: Nov. 14, 2013)

### SUMMARY OF INVENTION

### Technical Problem

In the above described conventional technique, a posture of the mobile terminal is detected with use of an acceleration sensor and the like. However, according to the conventional technique, the posture of the mobile terminal is merely detected with use of the acceleration sensor, and therefore the mobile terminal does not necessarily act in accordance with a user's intention. For example, there is a possibility of malfunction or false detection in that an action is executed based on a result of detection by the acceleration sensor without a user operation, or an action is executed based on a result of detection by the acceleration sensor and a user operation is not accepted.

The present invention is accomplished in view of the problem, and its object is to provide an information processing device and the like which can detect lifting of the device itself with a reduced possibility of false detection.

### Solution to Problem

In order to attain the object, the information processing device in accordance with an aspect of the present invention is an information processing device which is provided in an electronic apparatus and is configured to include: an acceleration obtaining section which obtains acceleration information indicative of acceleration that has been detected by an acceleration sensor which is mounted on the electronic apparatus; and a lifting determination section, in a case where acceleration conditions are satisfied, the lifting determination section determining that the electronic apparatus has been lifted, the acceleration conditions being as follows: (i) a waveform, which represents values of acceleration with respect to elapsed time, has a maximum value and a minimum value, the values of acceleration being indicated by the acceleration information obtained by the acceleration obtaining section, (ii) the acceleration is greater than a first predetermined value during a first predetermined period including a time point of the maximum value, and (iii) the acceleration is lower than a second predetermined value during a second predetermined period including a time point of the minimum value.

The information processing device in accordance with an aspect of the present invention is an information processing device which is provided in an electronic apparatus and is configured to include: an acceleration obtaining section which obtains acceleration information indicative of acceleration that has been detected by an acceleration sensor which is mounted on the electronic apparatus; an angle calculation section which calculates an angle of an image display surface of the electronic apparatus with respect to a horizontal plane based on a value of acceleration that has been obtained by the acceleration obtaining section; and a lifting determination section, in a case where the angle has become a predetermined angle within a seventh predetermined period from a state of indicating that the image display surface and the horizontal plane are parallel to each other, the lifting determination section determining that the electronic apparatus has been lifted.

The method in accordance with an aspect of the present invention for controlling an information processing device is a method for controlling an information processing device which is included in an electronic apparatus, the method including the steps of: obtaining acceleration information indicative of acceleration that has been detected by an acceleration sensor which is mounted on the electronic apparatus; and determining, in a case where acceleration conditions are satisfied, that the electronic apparatus has been lifted, the acceleration conditions being as follows: (i) a waveform, which represents values of acceleration with respect to elapsed time, has a maximum value and a minimum value, the values of acceleration being indicated by the acceleration information obtained in the obtaining step, (ii) the acceleration is greater than a first predetermined value during a first predetermined period including a time point of the maximum value, and (iii) the acceleration is lower than a second predetermined value during a second predetermined period including a time point of the minimum value.

### Advantageous Effects of Invention

According to an aspect of the present invention, in a case where: a waveform representing acceleration with respect to elapsed time has a maximum value and a minimum value; the acceleration is greater than the first predetermined value during the first predetermined period including the time point of the maximum value; and the acceleration is lower than the second predetermined value during the second predetermined period including the time point of the minimum value, it is determined that lifting has been carried out. From this, it is possible to accurately detect change in acceleration when the electronic apparatus is lifted, and this makes it possible to appropriately determine whether or not lifting has been carried out.

### BRIEF DESCRIPTION OF DRAWINGS

FIG. 1 is a block diagram illustrating a main part configuration of a mobile terminal in accordance with Embodiment 1 of the present invention.

FIG. 2 is a view illustrating an appearance of the mobile terminal. (a) of FIG. 2 is a view illustrating a front side (display section side), and (b) of FIG. 2 is a view illustrating a back side (side opposite from the display section).

FIG. 3 is a view illustrating a hardware configuration of the mobile terminal.

FIG. 4 is a view for explaining a mechanism in the mobile terminal for detecting lifting.

FIG. 5 is a flowchart showing a flow of processes in the mobile terminal.

FIG. 6 is a flowchart showing a flow of processes in Embodiment 2 of the present invention.

FIG. 7 is a view for explaining a mechanism for detecting lifting in Embodiment 2.

FIG. 8 is a block diagram illustrating a main part configuration of a mobile terminal in accordance with Embodiment 3 of the present invention.

FIG. 9 is a view for explaining processes in Embodiment 3.

FIG. 10 is a view illustrating a main part configuration of a mobile terminal in accordance with Embodiment 4 of the present invention.

FIG. 11 is a flowchart showing a flow of processes in Embodiment 4.

FIG. 12 is a flowchart showing a flow of processes in Embodiment 4.

FIG. 13 is a view for explaining a flow of processes in Embodiment 4. (a) of FIG. 13 is a view for explaining a state, and (b) of FIG. 13 is a flowchart showing a flow of processes.

FIG. 14 is a view for explaining a flow of processes in Embodiment 4. Each of (a) and (b) of FIG. 14 is a view for explaining a state, and (c) of FIG. 14 is a flowchart showing a flow of processes.

FIG. 15 is a flowchart showing a flow of processes in Embodiment 5 of the present invention.

### DESCRIPTION OF EMBODIMENTS

### Embodiment 1

### Overview of Mobile Terminal 1

The following description will discuss details of an embodiment of the present invention. A mobile terminal (electronic apparatus, information processing device) 1 in accordance with Embodiment 1 (i) appropriately detects that the mobile terminal 1 has been lifted and (ii) executes a process (e.g., causes a display section 21 to light up, turns on power, or the like) corresponding to the lifting.

First, the following describes an appearance of the mobile terminal 1 with reference to FIG. 2. FIG. 2 is a view illustrating an appearance of the mobile terminal 1. (a) of FIG. 2 is a view illustrating a front side (i.e., touch panel 12 side), and (b) of FIG. 2 is a view illustrating a back side (i.e., side opposite from the touch panel 12). As illustrated in FIG. 2, in Embodiment 1, the mobile terminal 1 is assumed to be a smart phone. Note, however, that the mobile terminal 1 is not limited to this, and can be a portable information processing device such as a mobile phone, a personal digital assistant, a portable television, or a portable personal computer.

FIG. 2 illustrates, as an example, a configuration in which proximity sensors 14 (14a, 14b) and a brightness sensor 15 are provided. Note, however, that those components are not essential in Embodiment 1.

### Hardware Configuration of Mobile Terminal 1

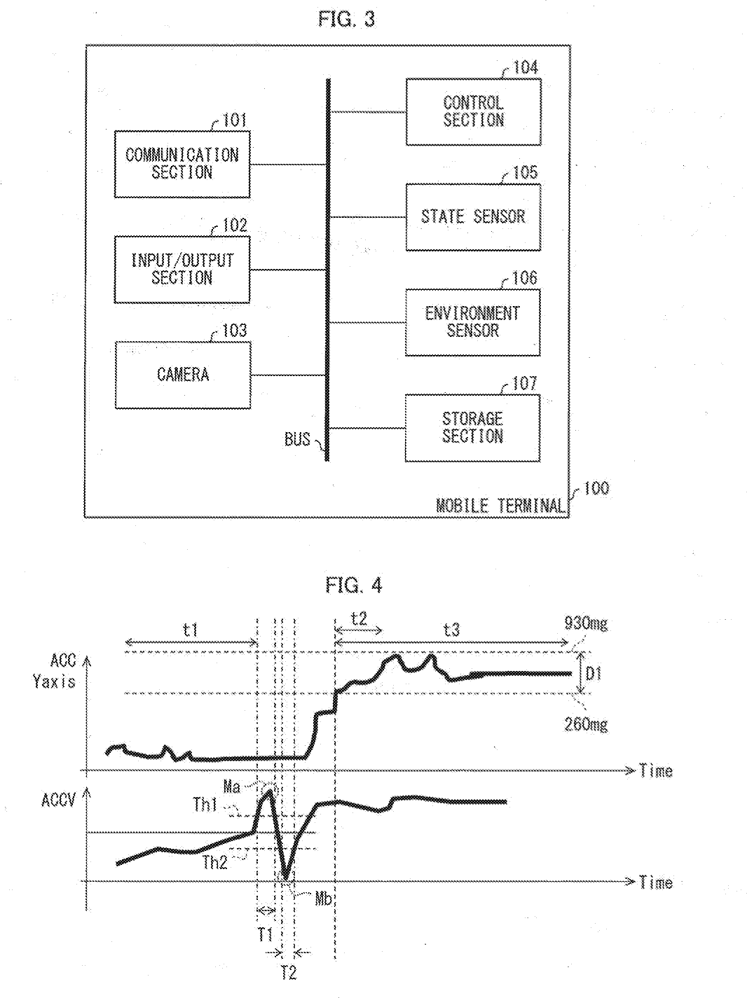

Next, the following describes a hardware configuration of the mobile terminal 1 with reference to FIG. 3. FIG. 3 is a view illustrating a typical hardware configuration of the mobile terminal. As illustrated in FIG. 3, the mobile phone has a configuration including a communication section 101, an input/output section 102, a camera 103, a control section 104, a state sensor 105, an environment sensor 106, and a storage section 107 which are connected with each other via a system bus. Note that the camera 103, the state sensor 105, and the environment sensor 106 are not essential components.

The communication section 101 communicates with an external device. The communication section 101 is connected with a mobile telephone network or the Internet wirelessly (e.g., WiFi (Registered Trademark)) or via a wire or is connected with the external device directly (e.g., by Bluetooth). In Embodiment 1, the communication section 101 corresponds to a communication section 13.

The input/output section 102 accepts an operation input by a user and presents information. In Embodiment 1, the input/output section 102 corresponds to a touch panel 12.

The control section 104 carries out various controls on the mobile terminal, and corresponds to a control section 10 in Embodiment 1.

The state sensor 105 detects a state of the mobile terminal. Examples of the state sensor 105 encompass an acceleration sensor, a gyro sensor, a geomagnetic sensor, an air pressure sensor, and the like. In Embodiment 1, the state sensor 105 corresponds to the acceleration sensor 11.

The environment sensor 106 detects circumstances around the mobile terminal. Examples of the environment sensor 106 encompass an illuminance sensor (brightness sensor), a proximity sensor, and the like.

### Main Part Configuration of Mobile Terminal 1

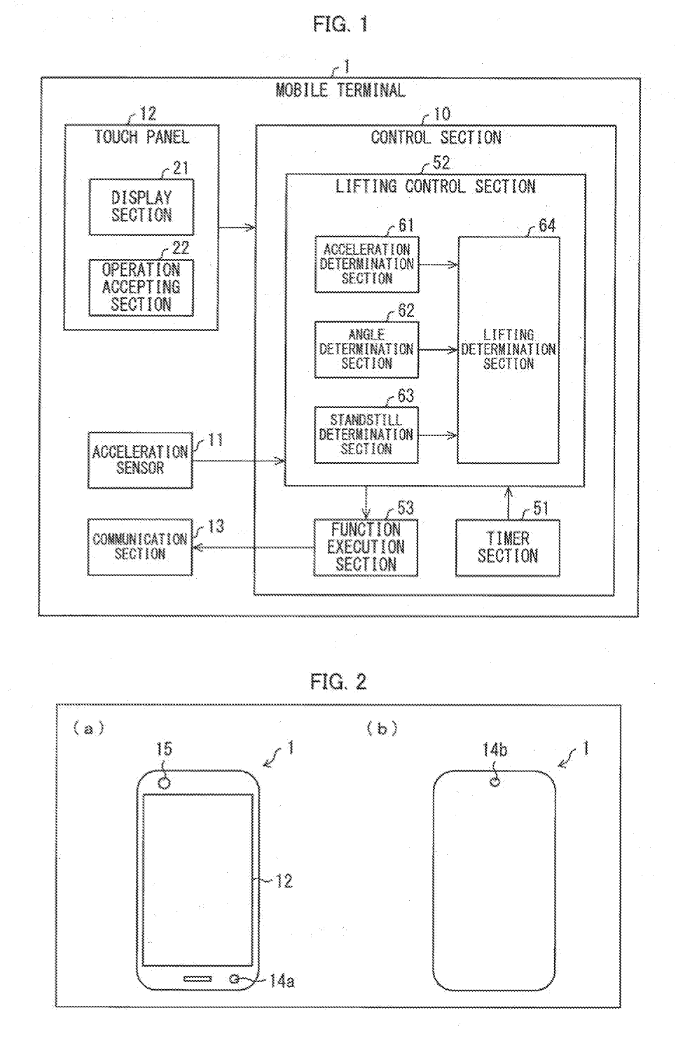

Next, the following describes a main part configuration of the mobile terminal 1 with reference to FIG. 1. FIG. 1 is a block diagram illustrating a main part configuration of the mobile terminal 1. As illustrated in FIG. 1, the mobile terminal 1 has a configuration including a control section 10, an acceleration sensor 11, a touch panel 12, and a communication section 13.

The control section 10 executes various processes in the mobile terminal 1 and detects whether or not the mobile terminal 1 has been lifted. In a case where the control section 10 has detected that the mobile terminal 1 had been lifted, the control section 10 executes a corresponding function. The control section 10 includes a timer section 51, a lifting control section (information processing device, acceleration obtaining section, information obtaining section) 52, and a function execution section 53.

The timer section 51 counts up time and notifies the lifting control section 52 of the time.

The lifting control section 52 detects whether or not the mobile terminal 1 has been lifted, and includes an acceleration determination section 61, an angle determination section (angle calculation section) 62, a standstill determination section 63, and a lifting determination section 64.

The acceleration determination section 61 determines whether or not acceleration notified from the acceleration sensor 11 satisfies the following three points (acceleration conditions), and notifies the lifting determination section of a result of the determination. (1) A waveform representing acceleration obtained during a predetermined period has a maximum value and a minimum value. (2) The acceleration is higher than a threshold Th1 (first predetermined value) during a predetermined time period T1 (first predetermined period) including the maximum value. (3) The acceleration is lower than a threshold Th2 (second predetermined value) during a predetermined time period T2 (second predetermined period) including the minimum value. Note that details of the process will be described later.

After the acceleration determination section 61 determines that the acceleration conditions are satisfied, the angle determination section 62 determines, with use of the acceleration obtained from the acceleration sensor 11, whether or not the mobile terminal 1 is at an angle within a predetermined range (i.e., whether or not an angle condition is satisfied), and notifies the lifting determination section 64 of a result of the determination. The angle within the predetermined range is, for example, an angle (e.g., 15 degrees to 68 degrees) which is of the display section (image display surface) 21 and includes 45 degrees with respect to a horizontal plane. At the angle within the predetermined range, the user is assumed to view the display section 21 while lifting the mobile terminal 1. Note that details of the process will be described later.

After the angle determination section 62 determines that the angle condition is satisfied, the standstill determination section 63 determines, with use of the acceleration obtained from the acceleration sensor 11, whether or not the mobile terminal 1 is in a standstill state while satisfying the angle condition (i.e., whether or not a standstill condition is satisfied), and notifies the lifting determination section 64 of a result of the determination. Note that details of the process will be described later.

In a case where the acceleration determination section 61 has determined that the acceleration conditions are satisfied, the angle determination section 62 has determined that the angle condition is satisfied, and the standstill determination section 63 has determined that the standstill condition is satisfied, the lifting determination section 64 determines that the mobile terminal 1 has been lifted. Note that it is possible to employ a configuration in which the mobile terminal 1 is determined to be lifted in a case where only the acceleration conditions are satisfied, instead of the case where the acceleration conditions, the angle condition, and the standstill condition are all satisfied.

In a case where the lifting determination section 64 has determined that the mobile terminal 1 had been lifted, the function execution section 53 executes a corresponding function. The corresponding function can be any function such as turning on display of the display section 21 (i.e., make it bright), turning on power, starting to communicate with another device, provided that the function corresponds to the lifting.

The acceleration sensor 11 detects acceleration in each of three directions which are perpendicular to each other, and notifies the lifting control section 52 of the detected acceleration as acceleration information.

The touch panel 12 displays information and accepts an operation by the user or the like with respect to the mobile terminal 1. The touch panel 12 includes a display section 21 and an operation accepting section 22. The display section 21 displays various kinds of information. The operation accepting section 22 accepts an operation which is made by contact or proximity of a finger or the like of the user.

The communication section 13 communicates with an external device.

### Details of Process in Lifting Control Section 52

Next, details of the process in the lifting control section 52 are described with reference to FIG. 4. FIG. 4 is a view for explaining a mechanism for detecting lifting. In FIG. 4, the horizontal axis represents time, and the vertical axis represents acceleration (in the upper graph, acceleration in a y-direction and, in the lower graph, synthetic acceleration in an x-direction, the y-direction, and a z-direction). Note that a shorter-side direction of the display section is the x-direction (x-axis), a longer-side direction of the display section is the y-direction (y-axis), and a direction which is perpendicular to the x-axis and the y-axis and in which the display section displays a screen is the z-direction (z-axis).

First, in a case where acceleration in the x-direction is less than −400 mg (g is gravitational acceleration) or higher than 400 mg and acceleration in the y-direction is 260 mg to 930 mg for 300 ms (t1) or longer, the mobile terminal 1 is in a state of being not lifted. Note that acceleration in the z-direction can be any level.

Next, in a case where synthetic acceleration V(m) at a time point m and synthetic acceleration V(n) at a time point n satisfy formulae below, the acceleration determination section 61 determines that a lifting action has been carried out.

V(m)≤1150 mg and min(V(m+1), V(m+2))>1150 mgV(n−P) . . . , V(n)<850 mg and min(V(n+1), V(n+2))≥850 mg, (P≥0)
180 ms≤Tb−Ta≤1500 ms, where Ta is a time point of V(m+2), and Tb is a time point of V(n+2)
Note that m+1 and m+2 represent a next time point after the time point m and a time point after the next time point, respectively. The next time point can be, for example, 50 ms after the time point m. Note that the next time point is not limited to this and can be any time point which is determined in advance and is a predetermined time period after the time point m.

By determining whether or not the above formulae are satisfied, it is possible to determine whether or not a predetermined action has been carried out within the predetermined period, that is, it is possible to determine whether or not (i) a waveform, which represents values of acceleration with respect to elapsed time within the predetermined period, has a maximum value and a minimum value, (ii) the acceleration is greater than the threshold Th1 during the predetermined time period T1 including the maximum value, and (iii) the acceleration is lower than the threshold Th2 during the predetermined time period T2 including the minimum value.

Note that above numerical values are mere examples, and can be determined as appropriate depending on a mobile terminal which is to achieve this function.

Next, the angle determination section 62 determines whether or not the display section 21 is at the predetermined angle (approximately 45 degrees at which the user views the display section 21) with respect to the horizontal plane. Specifically, the angle determination section 62 carries out the determination based on whether or not acceleration obtained from the acceleration sensor 11 falls within the following ranges: that is, acceleration in the y-direction is 260 mg to 930 mg (i.e., D1 in FIG. 4 corresponding to, e.g., approximately 15 degrees to 68 degrees); acceleration in the x-direction is −400 mg to 400 mg (corresponding to ±25 degrees); and the z-direction is an upward direction (in which the display section 21 displays a screen). Note that the determination is carried out multiple times (e.g., 7 times) for each predetermined interval (e.g., every 50 ms), and the angle determination section 62 determines that the display section 21 is at the predetermined angle with respect to the horizontal plane in a case where all determination results fall within the above ranges. That is, the angle determination section 62 determines whether or not the display section 21 is at the predetermined angle for a predetermined time period (350 ms: third predetermined period).

Next, the standstill determination section 63 determines whether or not the mobile terminal 1 is in a standstill state. Specifically, the standstill determination section 63 continuously obtains, from the acceleration sensor 11, acceleration in each of the directions for 350 ms at intervals of 50 ms, and carries out the determination based on whether or not dispersion of values except for a maximum value and a minimum value among those obtained values falls within 40 mg. That is, the standstill determination section 63 determines whether or not the mobile terminal 1 is in the standstill state for a predetermined time period (350 ms: fourth predetermined period). Alternatively, it is possible to start the above described determination process after an elapse of a predetermined period (t2, e.g., 200 ms: fifth predetermined period) after the standstill determination section 63 and the angle determination section 62 have determined that the values fall within the above ranges. This makes it possible to carry out the determination process while excluding a case in which the mobile terminal 1 is in an unstable state. In a case where the dispersion does not fall within 40 mg even after an elapse of 3 seconds (t3) from start of the determination process, a time-out occurs.

Then, in a case where the above conditions are satisfied, the lifting determination section 64 determines that lifting has been carried out.

Note that the lifting control section 52 can execute a next lifting determination process after an elapse of a predetermined time period (sixth predetermined period) from when a previous lifting determination process is executed.

### Flow of Processes in Mobile Terminal 1

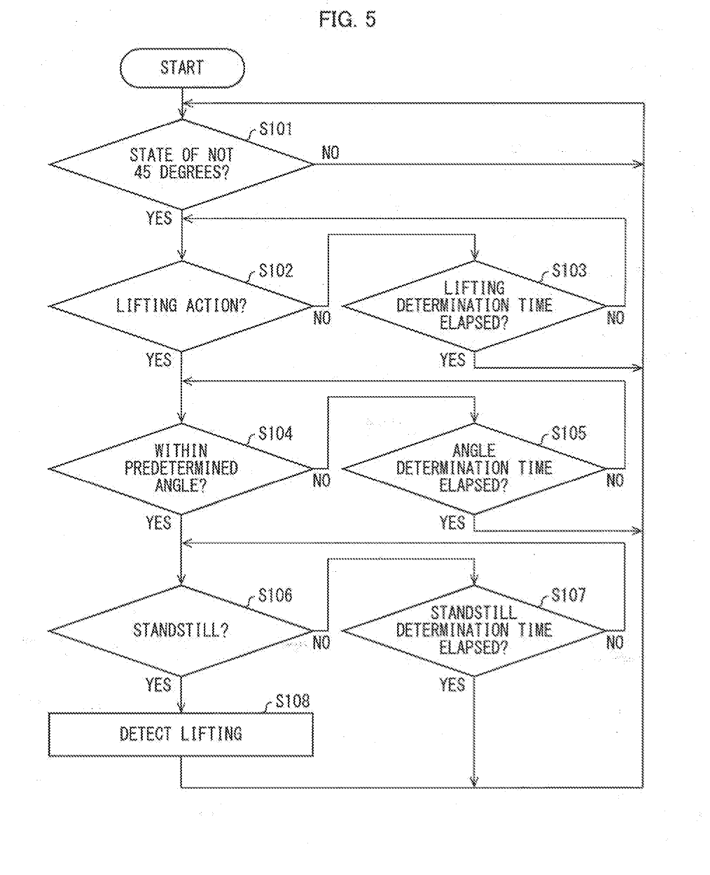

Next, the following describes a flow of processes in the mobile terminal 1 with reference to FIG. 5. FIG. 5 is a flowchart showing a flow of processes in the mobile terminal 1.

As shown in FIG. 5, in a state of being not within the predetermined angle (state of not 45 degrees) (YES in S101), the acceleration determination section 61 carries out determination on the acceleration conditions (lifting action) (S102, acceleration obtaining step). In a case where the acceleration conditions are satisfied (YES in S102), the angle determination section 62 carries out determination on the angle condition (S104). In a case where the angle determination section 62 has determined that the angle condition is satisfied (YES in S104), the standstill determination section 63 carries out determination on the standstill condition (S106). Then, in a case where the standstill determination section 63 has determined that the standstill condition is satisfied (YES in S106), the lifting determination section 64 determines that lifting has been carried out (S108, lifting determination step).

On the other hand, in a case where the acceleration conditions are not satisfied in the step S102 (NO in S102) and a predetermined time period (lifting determination time) has elapsed (YES in S103), the process returns to the step S101. Moreover, in a case where the angle condition is not satisfied in the step S104 (NO in S104) and a predetermined time period (angle determination time) has elapsed (YES in S105), the process returns to the step S101. Moreover, in a case where the standstill condition is not satisfied in the step S106 (NO in S106) and a predetermined time period (standstill determination time) has elapsed (YES in S107), the process returns to the step S101.

The above is the flow of processes in the mobile terminal 1.

### Embodiment 2

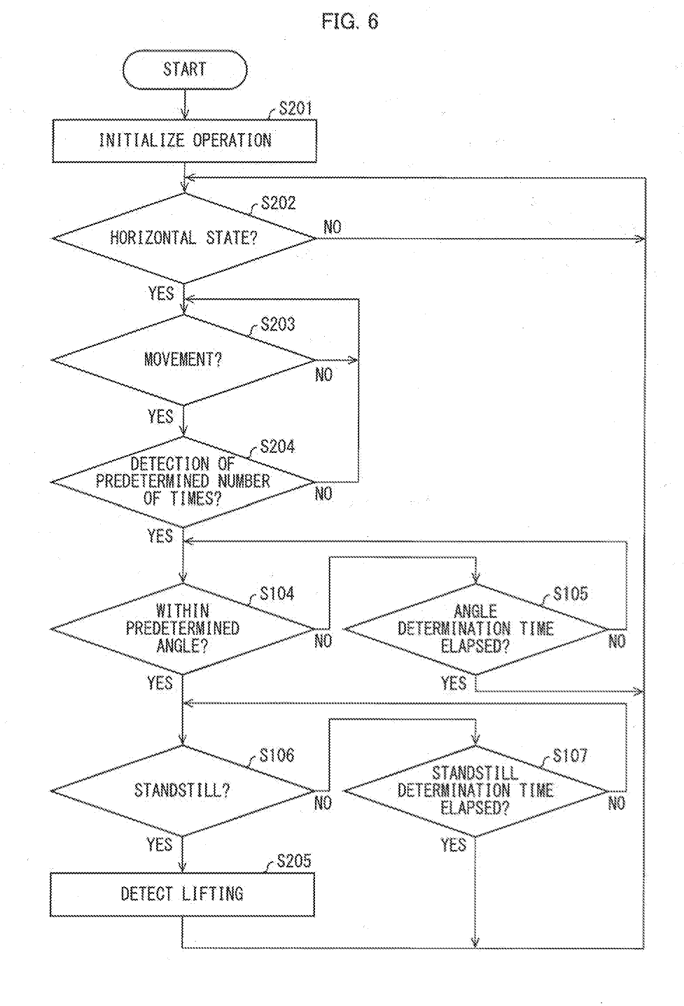

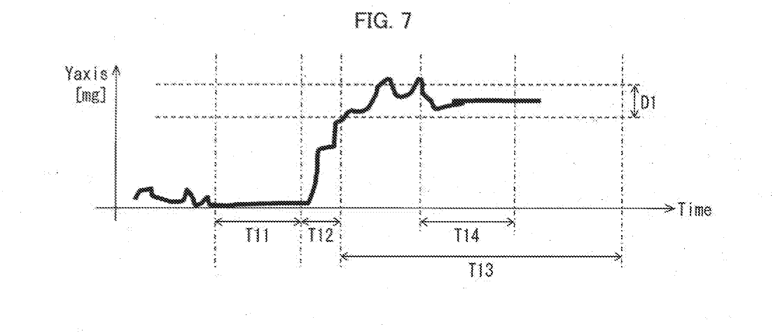

The following description will discuss another embodiment of the present invention with reference to FIGS. 6 and 7. For convenience of explanation, the same reference numerals are given to constituent members having functions identical with those described in the above embodiment, and descriptions of such constituent members are omitted.

In Embodiment 2, whether or not lifting has been carried out is determined based on whether the mobile terminal 1 in a horizontal state has entered a state of satisfying an angle condition. By firstly determining whether or not the mobile terminal 1 is in the horizontal state, it is possible to determine whether or not lifting has been carried out, without determining whether or not the acceleration conditions in Embodiment 1 are satisfied.

The following description will discuss a flow of processes in Embodiment 2 with reference to FIG. 6. FIG. 6 is a flowchart showing a flow of processes in Embodiment 2.

As illustrated in FIG. 6, in Embodiment 2, initialization is carried out first (S201). In the initialization, reference acceleration at a start of action is calculated. For example, the initialization is carried out by obtaining values every 50 ms and 40 times in each of the x-direction, the y-direction, and the z-direction. Subsequently, the angle determination section 62 determines whether or not the mobile terminal 1 is in the horizontal state (S202). This determination is carried out based on whether or not a state, in which a value which is of acceleration in each of the directions and has been obtained from the acceleration sensor 11 falls within a range of “±100 mg (within ±6 degrees)”, continues for a predetermined time period T11 (2 seconds) or longer.

In a case where the angle determination section 62 has determined that the mobile terminal 1 is in the horizontal state (YES in S202), next, the acceleration determination section 61 determines whether or not a change (i.e., movement) from the horizontal state to a state that satisfies the angle condition has occurred (S203). This determination is carried out based on whether or not acceleration obtained from the acceleration sensor 11 satisfies the following condition: Acceleration in the x-direction is 20 mg or higher or acceleration in the y-direction is 20 mg or higher; and acceleration in the z-direction is 30 mg or higher. Note that it is possible to employ a configuration in which the threshold is set as an absolute value for enhancing accuracy.

In a case where the above condition is satisfied (YES in S203), the acceleration determination section 61 determines whether or not the above condition is consecutively satisfied a predetermined number of times (e.g., two times) or more at intervals of 50 ms (S204). By carrying out the determination the predetermined number of times or more, it is possible to remove vibrational noises. Note that, in a case where the above condition is not satisfied for 2 seconds or longer, a time-out occurs.

In a case where the above condition has been consecutively satisfied the predetermined number of times or more (YES in S204), the angle determination section 62 and the standstill determination section 63 execute the steps S104 through S107 in Embodiment 1. Note that Embodiment 2 can employ a configuration in which the number of times the determination is carried out is less than that in Embodiment 1.

Then, in a case where the standstill condition is satisfied in the step S106 (YES in S106), the lifting determination section 64 determines that lifting has been carried out (S205).

The following description will discuss, with reference to FIG. 7, details of acceleration in the y-direction that is obtained in a case where lifting is detected. FIG. 7 is a graph showing acceleration in the y-direction that is obtained in a case where lifting is detected. In FIG. 7, a horizontal axis represents time and a vertical axis represents acceleration in the y-direction.

As shown in FIG. 7, in a case where the value of acceleration falls within the range of ±100 mg (±6 degrees) for a predetermined time period T11, the angle determination section 62 determines that the mobile terminal 1 is in the horizontal state. Next, the condition that the acceleration in the x-direction or the y-direction is 20 mg or higher and the acceleration in the z-direction is 30 mg or higher is satisfied two times or more during a time period T12 (seventh predetermined period), and therefore the acceleration determination section 61 determines that movement has occurred. Subsequently, the angle determination section 62 determines that the mobile terminal 1 is within the predetermined angle because the acceleration in the y-direction falls within the range from 260 mg to 930 mg (D1).

A time period T13 represents a time-out period (2 seconds) used in a case where the standstill determination section 63 carries out standstill determination. A time period T14 is a period during which the standstill determination section 63 continuously obtains, from the acceleration sensor 11, acceleration for 350 ms at intervals of 50 ms, and carries out the determination based on whether or not dispersion of values except for a maximum value and a minimum value among those obtained values falls within 40 mg.

### Embodiment 3

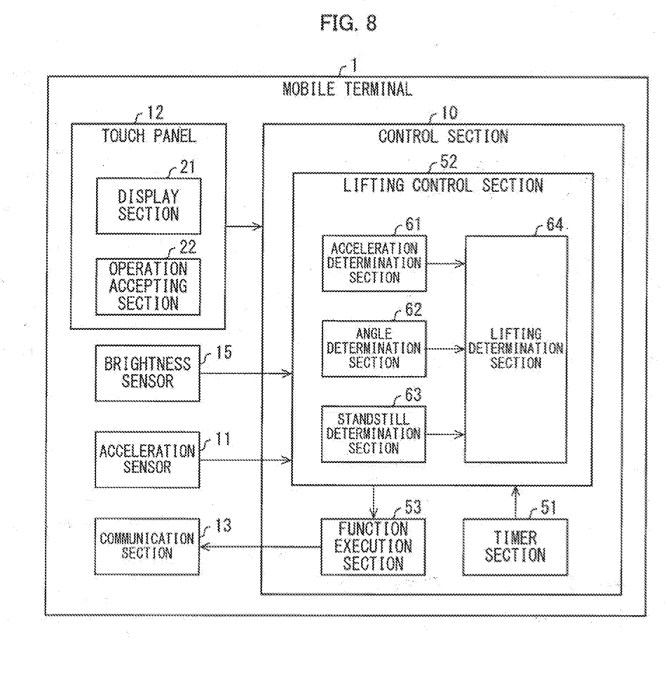

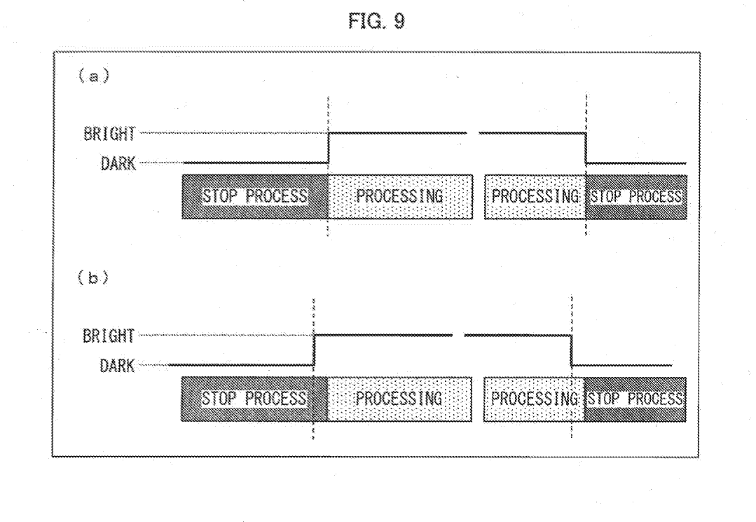

The following description will discuss still another embodiment of the present invention with reference to FIGS. 8 and 9. For convenience of explanation, the same reference numerals are given to constituent members having functions identical with those described in the above embodiments, and descriptions of such constituent members are omitted.

In Embodiment 3, a brightness sensor 15 is provided in addition to the configuration of Embodiment 1 or 2, and whether or not to execute a process of detecting lifting is determined based on a result of detection by the brightness sensor 15.

Details will be described with reference to FIG. 9. Each of (a) and (b) of FIG. 9 is a view illustrating a relation between detected brightness and whether to execute a lifting process. Here, the lifting detection process refers to the lifting detection process described in Embodiments 1 and 2.

In an example shown in (a) of FIG. 9, the lifting process is executed in a case where the brightness sensor 15 is detecting brightness that is a predetermined level or higher, whereas the lifting process is not executed in a case where the brightness sensor 15 is detecting brightness that is lower than the predetermined level.

In a case where the brightness detected by the brightness sensor 15 is lower than the predetermined level, the user is less likely to be near to the mobile terminal 1, and it is accordingly less likely that the mobile terminal 1 is to be lifted. Therefore, by refraining from executing the lifting detection process in such a case, it is possible to reduce power consumption.

In an example shown in (b) of FIG. 9, the lifting process is executed after a while from when the brightness sensor 15 has detected brightness that is the predetermined level or higher, whereas the lifting process is not executed after a while from when the brightness sensor 15 has detected brightness that is lower than the predetermined level. From this, it is possible to control execution of the lifting process while taking into consideration false detection that may be caused by chattering or the like.

Note that it is possible to employ a configuration in which a proximity sensor or a camera plays a role similar to the brightness sensor of Embodiment 3 and the above process is executed by the proximity sensor or the camera.

### Embodiment 4

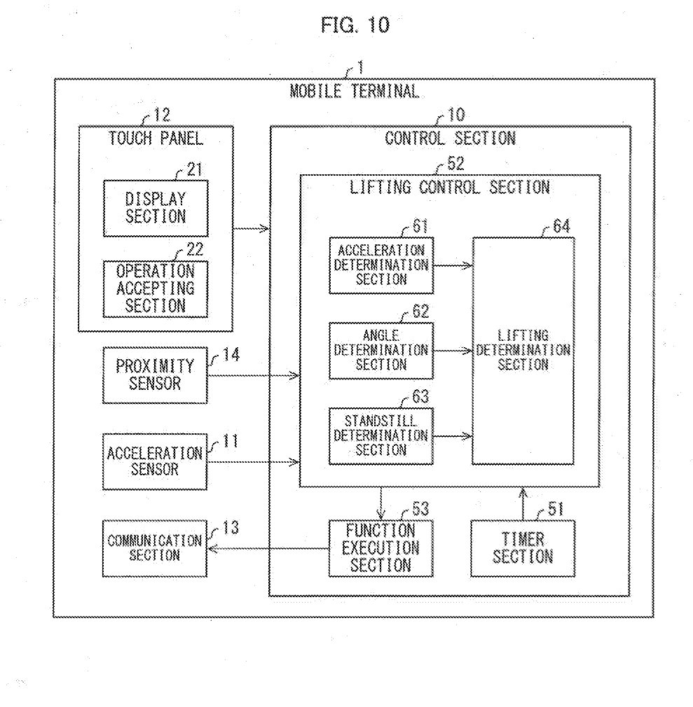

The following description will discuss still another embodiment of the present invention with reference to FIGS. 10 through 14. For convenience of explanation, the same reference numerals are given to constituent members having functions identical with those described in the above embodiments, and descriptions of such constituent members are omitted.

In Embodiment 4, a proximity sensor 14 is provided in addition to at least any of the configurations of Embodiments 1 through 3, and a lifting detection process is executed with use of also a result of detection (proximity information) by the proximity sensor 14. In Embodiment 4, an example configuration will be described in which a total of two proximity sensors 14 are provided respectively on a surface (i.e., front surface) that is identical to the display section 21 (14a) and on a surface (i.e., back surface) that is opposite from the display section 21 (14b). Note, however, that the number of proximity sensors 14 is not limited to two. For example, it is possible to employ a configuration in which the touch panel 12, a camera, or the like plays a role similar to that of the proximity sensor 14, and one of the proximity sensors 14 is not provided. Alternatively, it is possible to employ a configuration in which locations of the proximity sensors 14 on respective of the front surface and the back surface are different between the front surface and the back surface.

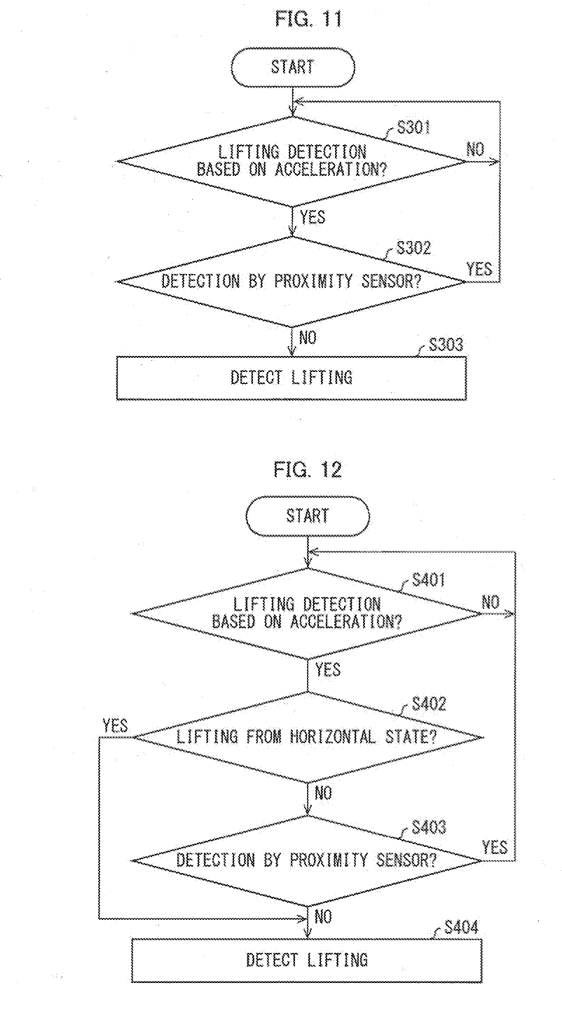

The following description will discuss a concrete flow of processes in Embodiment 4 with reference to FIGS. 11 through 14.

### Example 1 of using proximity sensor 14

In this example, the lifting detection process is not executed regardless of output from the acceleration sensor 11 while any of the two proximity sensors 14 is detecting an object (i.e., in a state in which some object is in proximity to the mobile terminal 1 (with a degree of proximity that is a predetermined distance or shorter)).

This is because the mobile terminal 1 is less likely to be lifted in a state in which an object is detected. The following is a concrete flow of processes.

First, as shown in FIG. 11, in a case where it is determined, based on acceleration detected by the acceleration sensor 11, that lifting has been carried out (YES in S301) as described in Embodiments 1 and 2 and then the proximity sensor 14 detects nothing (NO in S302), the lifting determination section 64 determines that lifting has been carried out (S303). In a case where the proximity sensor 14 detects an object, it is highly possible that there is some object near to the mobile terminal 1 and the mobile terminal 1 is not being lifted by the user. According to this configuration, it is possible to eliminate, from lifting detection, a case in which the mobile terminal 1 does not seem to be lifted by the user.

### Example 2 of using proximity sensor 14

Alternatively, as shown in FIG. 12, it is possible to carry out a process in which, in a case where it is determined, based on acceleration detected by the acceleration sensor 11, that lifting has been carried out as described in Embodiment 1 and it is not determined that lifting from the horizontal state has been carried out as described in Embodiment 2, whether or not lifting has been carried out is determined with use of a result of detection by the proximity sensor 14.

That is, as shown in FIG. 12, in a case where it is determined, based on acceleration detected by the acceleration sensor 11, that lifting has been carried out (YES in S401) as described in Embodiment 1, it is not determined that lifting from the horizontal state has been carried out (NO in S402) as in Embodiment 2, and the proximity sensor 14 detects an object (YES in S403), the lifting determination section 64 determines that lifting has been carried out (S404).

In a case where lifting has been carried out from the horizontal state, an orientation of the mobile terminal 1 is changed from the horizontal state. Therefore, lifting detection is less likely to be false detection. As such, according to the configuration, the result of the proximity sensor 14 is used in a case where the mobile terminal 1 is not lifted from the horizontal state, i.e., a case which is possibly of false detection. It is therefore possible to execute lifting detection with use of a result of detection by the proximity sensor 14 only in a necessary case.

### Example 3 of using proximity sensor 14

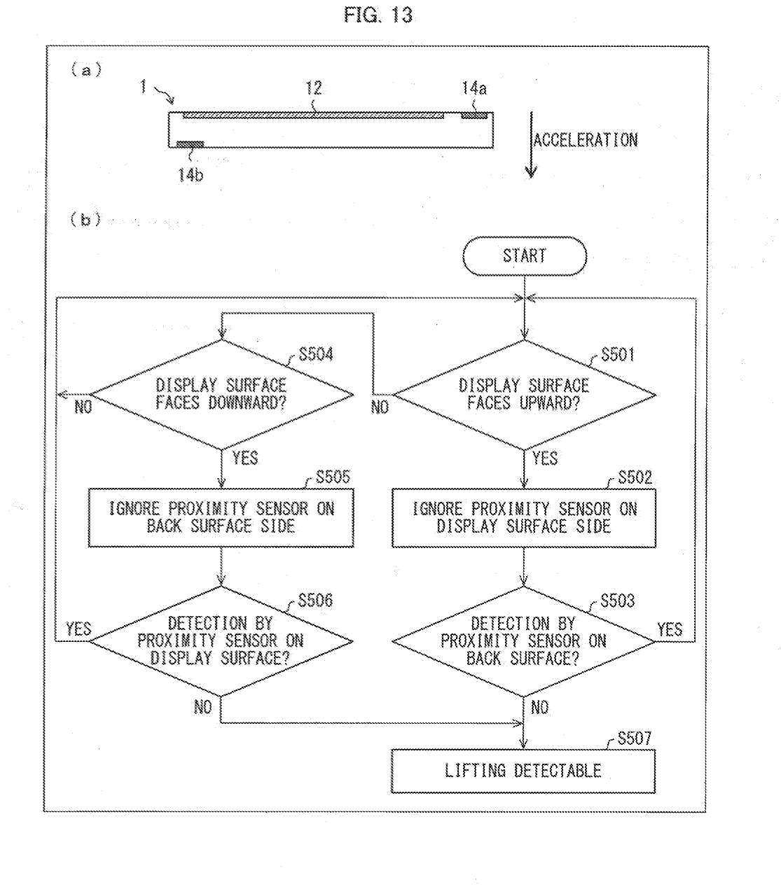

Alternatively, it is possible to carry out a process as shown in FIG. 13. In the process shown in FIG. 13, the proximity sensors 14 (14a and 14b) are respectively provided on the front side (i.e., display section 21 side) and the back side (i.e., opposite side from display section 21), and which one of the proximity sensors 14 is to be used is controlled depending on a state in which the mobile terminal 1 is placed. Specifically, in a case where the mobile terminal 1 is placed such that the front side faces upward, the proximity sensor 14a which is provided on the front side is not used, and only a result of detection by the proximity sensor 14b, which is provided on the back side, is used. On the contrary, in a case where the mobile terminal 1 is placed such that the back side faces upward, the proximity sensor 14b which is provided on the back side is not used, and a result of detection by the proximity sensor 14a, which is provided on the front side, is used.

The proximity sensor 14 that is provided on an upward surface may be covered when the user lifts the mobile terminal 1. Therefore, even in a case where the proximity sensor 14 is detecting proximity of an object, the mobile terminal 1 may be lifted. In view of this, according to the configuration, a result of detection by the proximity sensor 14 which may be covered by the user is not used and only a result of detection by the proximity sensor 14 that is provided on the opposite side surface is used to determine whether or not lifting has been carried out. This makes it possible to appropriately carry out determination on lifting with use of a result of detection by the proximity sensor 14.

The following description will discuss a flow of the processes with reference to (b) of FIG. 13. As shown in (b) of FIG. 13, in a case where the lifting control section 52 has determined that the display section (display surface) 21 of the mobile terminal 1 is facing upward (YES in S501), the lifting control section 52 does not use a result of detection by the proximity sensor 14a which is provided on the display section 21 side (S502). Then, in a case where the proximity sensor 14b which is provided on the back surface side detects nothing (NO in S503), the lifting detection process described in at least any of Embodiments 1 through 3 can be executed (S507).

In a case where the display section 21 is not facing upward in the step S501 (NO in S501), the lifting control section 52 determines whether or not the display section 21 is facing downward (S504). In a case where the lifting control section 52 has determined that the display section 21 is facing downward (YES in S504), the lifting control section 52 does not use a result of detection by the proximity sensor 14b which is provided on the side opposite from the display section 21 (S505). Then, in a case where the proximity sensor 14a which is provided on the front side detects nothing (NO in S506), the lifting detection process described in at least any of Embodiments 1 through 3 can be executed (S507).

### Example 4 of using proximity sensor 14

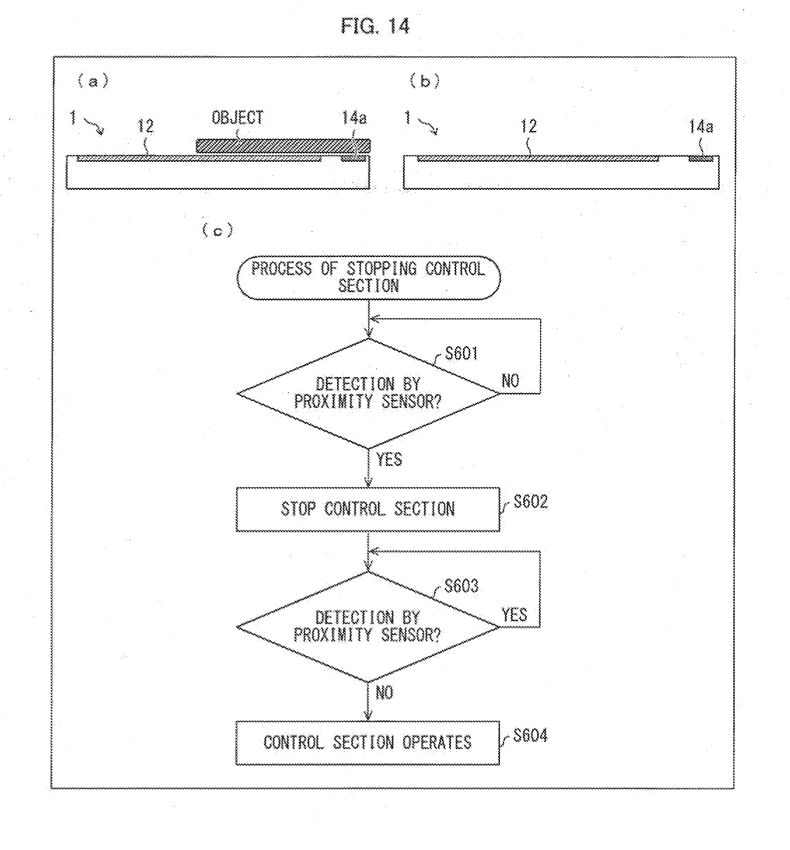

Alternatively, it is possible to employ a configuration in which the process of obtaining acceleration from the acceleration sensor 11 is not executed while the proximity sensor 14a is detecting an object (see FIG. 14). While the proximity sensor 14a is detecting an object, it is unnecessary to execute the lifting detection process, and it is therefore unnecessary to obtain acceleration from the acceleration sensor 11 during that time. As such, according to Embodiment 4, acceleration is not obtained while it is not necessary to do so, and this makes it possible to reduce power consumption. For example, in a state in which an object is detected by the proximity sensor 14a as illustrated in (a) of FIG. 14, the mobile terminal 1 is less likely to be lifted during the state, and it is therefore unnecessary to obtain acceleration from the acceleration sensor 11 during the state. In view of this, during such a state, the lifting control section 52 refrains from obtaining acceleration, and acceleration is obtained after the mobile terminal 1 enters a state in which the proximity sensor 14a does not detect any object as illustrated in (b) of FIG. 14.

Note that there is a time difference between when the object actually goes away from the mobile terminal 1 and when the mobile terminal 1 enters the state in which the proximity sensor 14a does not detect the object. Further, after the proximity sensor 14a does not detect the object, it may require time until acceleration is obtained from the acceleration sensor 11. In view of this, while the proximity sensor 14a is detecting the object, it is preferable to store data of acceleration values for a predetermined time period with use of a First in First out (FIFO) function that is embedded in the acceleration sensor 11.

The following description will discuss a flow of processes in this example with reference to (c) of FIG. 14. (c) of FIG. 14 is a flowchart showing a flow of the processes. As shown in (c) of FIG. 14, in a case where the proximity sensor 14a is detecting an object (YES in S601), the lifting control section 52 stops obtaining acceleration from the acceleration sensor 11 (S602). After that, in a case where the proximity sensor 14a detects nothing (YES in S603), the lifting control section 52 resumes obtaining acceleration from the acceleration sensor 11 (S604).

### Embodiment 5

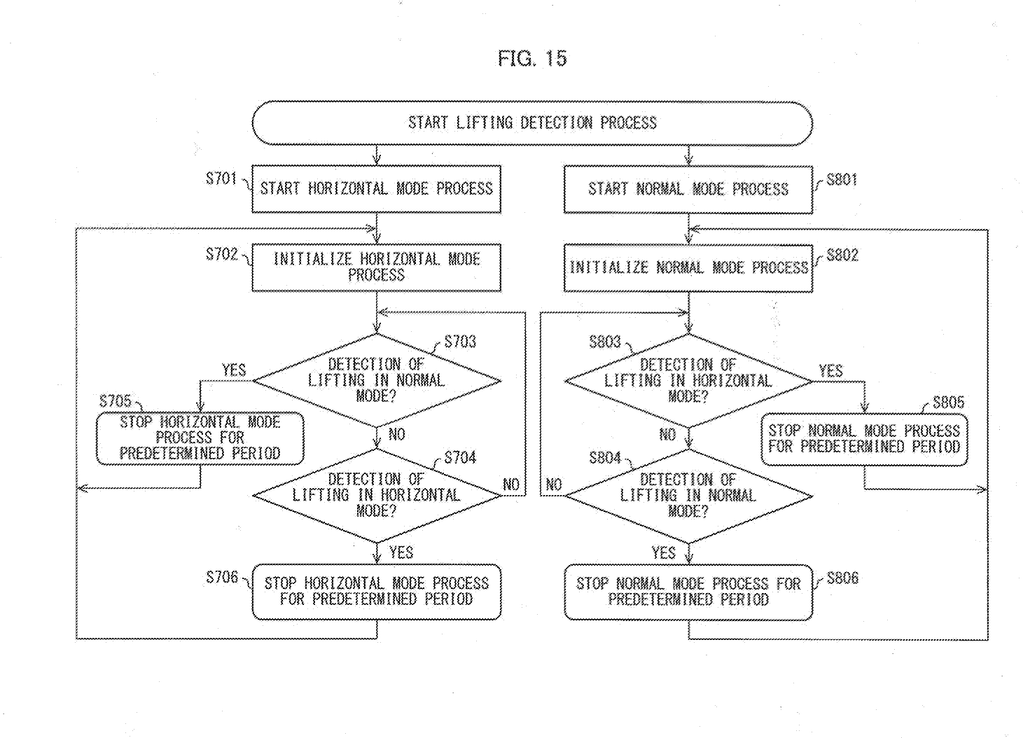

The following description will discuss still another embodiment of the present invention with reference to FIG. 15. For convenience of explanation, the same reference numerals are given to constituent members having functions identical with those described in the above embodiments, and descriptions of such constituent members are omitted.

In Embodiment 5, the lifting detection process (referred to as “normal mode process”) described in Embodiment 1 and the lifting detection process (referred to as “horizontal mode process”) described in Embodiment 2 are executed in parallel.

With reference to FIG. 15, the following description will discuss a flow of processes in which the normal mode process and the horizontal mode process are executed in parallel. FIG. 15 is a flowchart showing a flow of processes in which the normal mode process and the horizontal mode process are executed in parallel.

As illustrated in FIG. 15, in a case where the horizontal mode process has started (S701), first, the horizontal mode process is initialized (S702). After that, in a case where lifting has been detected by the normal mode process (YES in S703), the horizontal mode process is stopped for a predetermined time period (e.g., 2 seconds) (S705), and the process returns to the step S702. In a case where lifting is not detected by the normal mode process in the step S703 (NO in S703) and lifting has been detected by the horizontal mode process (YES in S704), the horizontal mode process is stopped for a predetermined time period (e.g., 2 seconds) (S706), and the process returns to the step S702.

In a case where the normal mode process has started (S801), first, the normal mode process is initialized (S802). After that, in a case where lifting has been detected by the horizontal mode process (YES in S803), the normal mode process is stopped for a predetermined time period (e.g., 2 seconds) (S805), and the process returns to the step S802. In a case where lifting is not detected by the horizontal mode process in the step S803 (NO in S803) and lifting has been detected by the normal mode process (YES in S804), the normal mode process is stopped for a predetermined time period (e.g., 2 seconds) (S806), and the process returns to the step S802.

As such, in a case where the normal mode process and the horizontal mode process are executed in parallel and any of the normal mode process and the horizontal mode process has detected lifting, the process which has detected lifting is initialized. Moreover, before the initialization, the process is stopped for a predetermined time period in order to prevent malfunction.

### Embodiment 6 (Example of Configuration Achieved by Software)

Control blocks of the mobile terminal 1 (in particular, the control section 10 (the timer section 51, the lifting control section 52 (the acceleration determination section 61, the angle determination section 62, the standstill determination section 63, and the lifting determination section 64), and the function execution section 53)) can be realized by a logic circuit (hardware) provided in an integrated circuit (IC chip) or the like or can be alternatively realized by software as executed by a central processing unit (CPU).

In the latter case, the mobile terminal 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### Recap

The information processing device (lifting control section 52) in accordance with an aspect 1 of the present invention is an information processing device which is provided in an electronic apparatus (mobile terminal 1) and is configured to include: an acceleration obtaining section (lifting control section 52) which obtains acceleration information indicative of acceleration that has been detected by an acceleration sensor (11) which is mounted on the electronic apparatus; and a lifting determination section (64), in a case where acceleration conditions are satisfied, the lifting determination section determining that the electronic apparatus has been lifted, the acceleration conditions being as follows: (i) a waveform, which represents values of acceleration with respect to elapsed time, has a maximum value and a minimum value, the values of acceleration being indicated by the acceleration information obtained by the acceleration obtaining section, (ii) the acceleration is greater than a first predetermined value during a first predetermined period including a time point of the maximum value, and (iii) the acceleration is lower than a second predetermined value during a second predetermined period including a time point of the minimum value.

In a case where the electronic apparatus is lifted, acceleration increases while the electronic apparatus is being lifted, and acceleration once decreases after the lifting. Then, according to the configuration, in a case where: a waveform representing acceleration with respect to elapsed time has a maximum value and a minimum value; the acceleration is greater than the first predetermined value during the first predetermined period including the time point of the maximum value; and the acceleration is lower than the second predetermined value during the second predetermined period including the time point of the minimum value, it is determined that lifting has been carried out. That is, the lifting is determined by detecting that the acceleration has increased (i.e., become greater than the first predetermined value) and that the acceleration has decreased (i.e., become lower than the second predetermined value). From this, it is possible to accurately detect change in acceleration when the electronic apparatus is lifted, and this makes it possible to appropriately carry out determination on whether or not lifting has been carried out.

The information processing device in accordance with an aspect 2 of the present invention can be configured, in the aspect 1, to further include: an angle calculation section which calculates an angle of an image display surface (display section 21) of the electronic apparatus with respect to a horizontal plane based on a value of acceleration that is indicated by acceleration information which the acceleration obtaining section has obtained, in a case where the acceleration conditions are satisfied and the angle which has been calculated by the angle calculation section falls within a predetermined angle, the lifting determination section determining that the electronic apparatus has been lifted.

In a case where the user lifts the electronic apparatus, the display surface of the electronic apparatus is often in a state of having an angle with respect to a horizontal plane (i.e., in a state of being not parallel to the horizontal plane). Under the circumstances, according to the configuration, lifting is determined in a case where the angle of the display surface falls within the predetermined angle in addition to the case where the acceleration conditions are satisfied. From this, it is possible to more accurately carry out determination on whether or not lifting has been carried out.

In the information processing device in accordance with an aspect 3 of the present invention, it is possible in the aspect 2 that, in a case where the angle which has been calculated by the angle calculation section falls within the predetermined angle for a third predetermined period or longer, the lifting determination section determines that the electronic apparatus has been lifted.

According to the configuration, it is possible to prevent determination that lifting has been carried out, which determination is made in a case where the angle of the display surface with respect to the horizontal plane happens to fall within the predetermined angle. It is therefore possible to more accurately carry out determination on whether or not lifting has been carried out.

The information processing device in accordance with an aspect 4 of the present invention can be configured, in the aspect 2 or 3, to further include: a standstill determination section which determines, based on a value of acceleration that is indicated by acceleration information which the acceleration obtaining section has obtained, whether or not the electronic apparatus is in a standstill state, in a case where the angle which has been calculated by the angle calculation section falls within the predetermined angle and the standstill state has continued for a fourth predetermined period or longer, the lifting determination section determining that the electronic apparatus has been lifted.

After the user lifts the electronic apparatus, the electronic apparatus is highly possibly in a standstill state such that the user views the display surface or the like. According to the configuration, determination that lifting has been carried out is made in a case where the electronic apparatus which is falling within the predetermined angle is in the standstill state, and it is therefore possible to more accurately carry out determination on whether or not lifting has been carried out.

Moreover, for example, in a case where the electronic apparatus is placed in a folder or the like in a vehicle, the electronic apparatus does not enter the standstill state and therefore lifting is not determined. As such, it is possible to prevent false determination that lifting has been carried out, which false determination may be made in such a case.

In the information processing device in accordance with an aspect 5 of the present invention, it is possible in the aspect 4 that the lifting determination section determines whether or not the fourth predetermined period has elapsed from a time point at which a fifth predetermined period has elapsed after the angle which has been calculated by the angle calculation section has come to fall within the predetermined angle.

After the electronic apparatus is lifted, an orientation and a location of the electronic apparatus often do not become stable soon. Therefore, immediately after lifting, it is highly possible that the electronic apparatus is in a state that is inappropriate for the determination process. In view of this, according to the configuration, whether or not the third predetermined period has elapsed is not determined soon after the angle of the display surface falls within the predetermined angle, and this makes it possible to more accurately carry out determination on whether or not lifting has been carried out.

In the information processing device in accordance with an aspect 6 of the present invention, it is possible in any one of the aspects 1 through 5 that the lifting determination section carries out determination on whether or not lifting has been carried out and then, after a sixth predetermined period has elapsed, the lifting determination section carries out next determination on whether or not lifting has been carried out.

According to the configuration, after determination on whether or not lifting has been carried out is made, next determination on whether or not lifting has been carried out is made after an elapse of the sixth predetermined period. This makes it possible to prevent the lifting determination process from being further executed in a state in which the electronic apparatus is lifted. Moreover, after the elapse of the sixth predetermined period, the next determination on whether or not lifting has been carried out is made. From this, in a case where the user lifts the electronic apparatus in that state, it is determined that the electronic apparatus has been lifted, and it is thus possible to prevent a case where the electronic apparatus is not determined to be lifted even though the user has lifted the electronic apparatus.

In the information processing device in accordance with an aspect 7 of the present invention, it is possible in any one of the aspects 1 through 6 that the electronic apparatus includes at least any of a brightness sensor and a proximity sensor; the information processing device includes an information obtaining section which obtains at least any of (i) brightness information indicative of brightness which the brightness sensor has detected and (ii) proximity information indicative of a degree of proximity of an object which the proximity sensor has detected; and in a case where the brightness information obtained by the information obtaining section indicates brightness that is equal to or lower than a predetermined level or in a case where the proximity information obtained by the information obtaining section indicates a degree of proximity that is equal to or shorter than a predetermined distance, the lifting determination section does not determine that the electronic apparatus has been lifted.

In a case where the brightness sensor has detected brightness that is equal to or lower than the predetermined level or in a case where the proximity sensor has detected a degree of proximity of an object which degree of proximity is equal to or shorter than the predetermined distance, it is highly possible that the electronic apparatus is placed on a desk or the like. According to the configuration, in a case where the brightness sensor has detected brightness that is equal to or lower than the predetermined level or in a case where the proximity sensor has detected proximity of an object which proximity is equal to or shorter than the predetermined distance, it is not determined that lifting has been carried out. Therefore, it is possible to prevent a case where determination that lifting has been carried out is mistakenly made.

The information processing device in accordance with an aspect 8 of the present invention is an information processing device which is provided in an electronic apparatus and includes: an acceleration obtaining section which obtains acceleration information indicative of acceleration that has been detected by an acceleration sensor which is mounted on the electronic apparatus; an angle calculation section which calculates an angle of an image display surface of the electronic apparatus with respect to a horizontal plane based on a value of acceleration that has been obtained by the acceleration obtaining section; and a lifting determination section, in a case where the angle has become a predetermined angle within a seventh predetermined period from a state of indicating that the image display surface and the horizontal plane are parallel to each other, the lifting determination section determining that the electronic apparatus has been lifted.

In a case where a device which is in a horizontal state has entered a state that is different from the horizontal state in a short time, it is highly possible that the device has been lifted. According to the configuration, it is determined that lifting has been carried out in a case where the device in the horizontal state has come to have the predetermined angle within the sixth predetermined period, and it is therefore possible to appropriately determine that the device has been lifted.

The information processing device which includes a lifting determination section in accordance with an aspect of the present invention, in a case where a lifting determination process has been executed by one of lifting determination sections, a lifting determination process, which is executed by the other of the lifting determination sections with respect to the same action, being initialized, can be configured, in any one of the aspects 1 through 7, to include the lifting determination section described in any one of the aspects 1 through 7 and the lifting determination section described in claim 8, in a case where a lifting determination process has been executed by one of the lifting determination sections, a lifting determination process, which is executed by the other of the lifting determination sections with respect to the same action, being initialized.

According to the configuration, lifting determination processes can be executed with a plurality of methods, and it is possible to prevent a case in which, when a lifting determination process is executed by one of the methods with respect to one action, another lifting determination process is executed by the other of the methods with respect to the one action.

The electronic apparatus in accordance with an aspect 10 of the present invention which includes an information processing device, an acceleration sensor, and a display surface can be configured, in any one of the aspects 1 through 9, to include the information processing device described in any one of the aspects 1 through 9, an acceleration sensor, and a display surface. According to the aspect, it is possible to bring about an effect similar to that of the aspect 1.

The method in accordance with an aspect 11 of the present invention for controlling an information processing device is a method for controlling an information processing device which is included in an electronic apparatus, the method including the steps of: obtaining acceleration information indicative of acceleration that has been detected by an acceleration sensor which is mounted on the electronic apparatus; and determining, in a case where acceleration conditions are satisfied, that the electronic apparatus has been lifted, the acceleration conditions being as follows: (i) a waveform, which represents values of acceleration with respect to elapsed time, has a maximum value and a minimum value, the values of acceleration being indicated by the acceleration information obtained in the obtaining step, (ii) the acceleration is greater than a first predetermined value during a first predetermined period including a time point of the maximum value, and (iii) the acceleration is lower than a second predetermined value during a second predetermined period including a time point of the minimum value. According to the aspect, it is possible to bring about an effect similar to that of the aspect 1.

The information processing device in accordance with each of the aspects of the present invention can be realized by a computer. In such a case, the present invention encompasses (i) a control program of the information processing device which control program causes the computer to serve as the sections (software elements) included in the information processing device for realizing the information processing device and (ii) a computer-readable storage medium storing the control program.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Mobile terminal (electronic apparatus)
11: Acceleration sensor
14, 14a, 14b: Proximity sensor
15: Brightness sensor
21: Display section (image display surface)
52: Lifting control section (information processing device, acceleration obtaining section, lifting determination section, information obtaining section)
53: Function execution section
61: Acceleration determination section (lifting determination section)
62: Angle determination section (lifting determination section, angle calculation section)
63: Standstill determination section (lifting determination section)
64: Lifting determination section

1. An information processing device which is provided in an electronic apparatus, said information processing device comprising:
an acceleration obtaining section which obtains acceleration information indicative of acceleration that has been detected by an acceleration sensor which is mounted on the electronic apparatus; and
a lifting determination section, in a case where acceleration conditions are satisfied, the lifting determination section determining that the electronic apparatus has been lifted,
the acceleration conditions being as follows: (i) a waveform, which represents values of acceleration with respect to elapsed time, has a maximum value and a minimum value, the values of acceleration being indicated by the acceleration information obtained by the acceleration obtaining section, (ii) the acceleration is greater than a first predetermined value during a first predetermined period including a time point of the maximum value, and (iii) the acceleration is lower than a second predetermined value during a second predetermined period including a time point of the minimum value.

2. The information processing device as set forth in claim 1, further comprising:
an angle calculation section which calculates an angle of an image display surface of the electronic apparatus with respect to a horizontal plane based on a value of acceleration that is indicated by acceleration information which the acceleration obtaining section has obtained,
in a case where the acceleration conditions are satisfied and the angle which has been calculated by the angle calculation section falls within a predetermined angle, the lifting determination section determining that the electronic apparatus has been lifted.

3. The information processing device as set forth in claim 2, wherein:
in a case where the angle which has been calculated by the angle calculation section falls within the predetermined angle for a third predetermined period or longer, the lifting determination section determines that the electronic apparatus has been lifted.

4. The information processing device as set forth in claim 2, further comprising:
a standstill determination section which determines, based on a value of acceleration that is indicated by acceleration information Which the acceleration obtaining section has obtained, whether or not the electronic apparatus is in a standstill state,
in a case where the angle which has been calculated by the angle calculation section falls within the predetermined angle and the standstill state has continued for a fourth predetermined period or longer, the lifting determination section determining that the electronic apparatus has been lifted.

5. The information processing device as set forth in claim 4, wherein:
the lifting determination section determines whether or not the fourth predetermined period has elapsed from a time point at which a fifth predetermined period has elapsed after the angle which has been calculated by the angle calculation section has come to fall within the predetermined angle.

6. The information processing device as set forth in claim 1, wherein:
the lifting determination section carries out determination on whether or not lifting has been carried out and then, after a sixth predetermined period has elapsed, the lifting determination section carries out next determination on whether or not lifting has been carried out.

7. The information processing device as set forth in claim 1, wherein:
the electronic apparatus includes at least any of a brightness sensor and a proximity sensor;
said information processing device comprises an information obtaining section which obtains at least any of (i) brightness information indicative of brightness which the brightness sensor has detected and (ii) proximity information indicative of a degree of proximity of an object which the proximity sensor has detected; and
in a case where the brightness information obtained by the information obtaining section indicates brightness that is equal to or lower than a predetermined level or in a case where the proximity information obtained by the information obtaining section indicates a degree of proximity that is equal to or shorter than a predetermined distance, the lifting determination section does not determine that the electronic apparatus has been lifted.

8. An information processing device which is provided in an electronic apparatus, said information processing device comprising:
an acceleration obtaining section which Obtains acceleration information indicative of acceleration that has been detected by an acceleration sensor which is mounted on the electronic apparatus;
an angle calculation section which calculates an angle of an image display surface of the electronic apparatus with respect to a horizontal plane based on a value of acceleration that has been Obtained by the acceleration obtaining section; and
a lifting determination section, in a case where the angle has become a predetermined angle within a seventh predetermined period from a state of indicating that the image display surface and the horizontal plane are parallel to each other, the lifting determination section determining that the electronic apparatus has been lifted.

9. An information processing device comprising a lifting determination section recited in claim 1 and a lifting determination section recited in claim 8,
in a case where a lifting determination process has been executed by one of the lifting determination sections, a lifting determination process, which is executed by the other of the lifting determination sections with respect to the same action, being initialized.

10. An electronic apparatus comprising:
an information processing device recited in claim 1;
an acceleration sensor; and
a display surface.

11. A method for controlling an information processing device which is included in an electronic apparatus, said method comprising the steps of:
obtaining acceleration information indicative of acceleration that has been detected by an acceleration sensor which is mounted on the electronic apparatus; and
determining, in a case where acceleration conditions are satisfied, that the electronic apparatus has been lifted,
the acceleration conditions being as follows: (i) a waveform, which represents values of acceleration with respect to elapsed time, has a maximum value and a minimum value, the values of acceleration being indicated by the acceleration information obtained in the obtaining step, (ii) the acceleration is greater than a first predetermined value during a first predetermined period including a time point of the maximum value, and (iii) the acceleration is lower than a second predetermined value during a second predetermined period including a time point of the minimum value.

12. A non-transitory storage medium storing a control program for causing a computer to serve as an information processing device recited in claim 1, said control program causing the computer to serve as the lifting determination section.
